(19) United States
(12) Patent Application Publication
(10) Pub. No.: US 2009/0327405 A1
(43) Pub. Date: Dec. 31, 2009

(54) Enhanced Client And Server Systems for Operating Collaboratively Within Shared Workspaces

(75) Inventors: Maura Janet FitzGerald, Swampscott, MA (US); Ransom Lloyd Richardson, Beverly, MA (US); Nithya Ramkumar, Redmond, WA (US); Gail Elaine Slapikoff, Chelmsford, MA (US); Dana Zircher, Woburn, MA (US); Edward J. Fischer, Cambridge, MA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/163,020

(22) Filed: Jun. 27, 2008

(51) Int. Cl. G06F 15/16

(52) U.S. Cl. 709/203

(57) ABSTRACT

Tools and techniques are described for enhanced client and server systems for operating collaboratively within shared workspaces. These tools may provide methods that include receiving document content associated with a workspace that is shared with one or more client systems. The client system may facilitate and manage the shared workspace. These methods may include receiving search commands that reference a search string, and searching the document content within the shared workspace for the search string. If the search string occurs anywhere within the shared workspace, the methods may report where the search string occurs within the shared workspace.

### BACKGROUND

Tools for collaboration or file sharing may operate on a client-server model, in which certain functions are allocated to the server and other functions are permitted to the client. In cases where the client goes off-line, the client may be able to perform some limited functionality.

### SUMMARY

Tools and techniques are described for enhanced client and server systems for operating collaboratively within shared workspaces. These tools may provide methods that include receiving document content associated with a workspace that is shared with one or more client systems. The client system may facilitate and manage the shared workspace. These methods may include receiving search commands that reference a search string, and searching the document content within the shared workspace for the search string. If the search string occurs anywhere within the shared workspace, the methods may report where the search string occurs within the shared workspace.

The above-described subject matter may also be implemented as a method, computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating systems or operating environments for enhanced client systems for operating collaboratively within shared workspaces, while cooperating with a centralized server system.

FIG. 2 is a block diagram illustrating additional aspects of the operating environments shown in FIG. 1.

FIG. 3 is a block diagram illustrating data structures and hierarchies relating to libraries as shown in FIG. 1.

FIG. 4 is a flow chart illustrating processes that may operate with the libraries.

FIG. 5 is a combined block and flow diagram illustrating components and data flows by which server systems may enable client systems to view and edit metadata and other server properties.

FIG. 6 is a combined block and flow diagram illustrating components and data flows that enable peer or client systems to sync binary contents of the files or documents from server systems.

FIG. 7 is a combined block and flow diagram illustrating components and flows related to managing public and private views of folders and documents on client and server systems.

FIG. 8 is a flow chart illustrating processes for integrating content accessible through a shared workspace with a search function operating on client systems.

FIG. 9 is a combined block and flow diagram illustrating components and flows by which client systems may check out items from server systems.

FIG. 10 is a combined block and flow diagram illustrating components and data flows related to a recycle bin structure associated with a shared workspace by which two or more client systems may collaborate.

FIG. 11 is a combined block and flow diagram illustrating components and data flows pertaining to various types of conflicts that may arise between revisions.

### DETAILED DESCRIPTION

The following detailed description is directed to technologies for enhanced client and server systems for operating collaboratively within shared workspaces. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of tools and techniques for enhanced client and server systems for operating collaboratively within shared workspaces will be described.

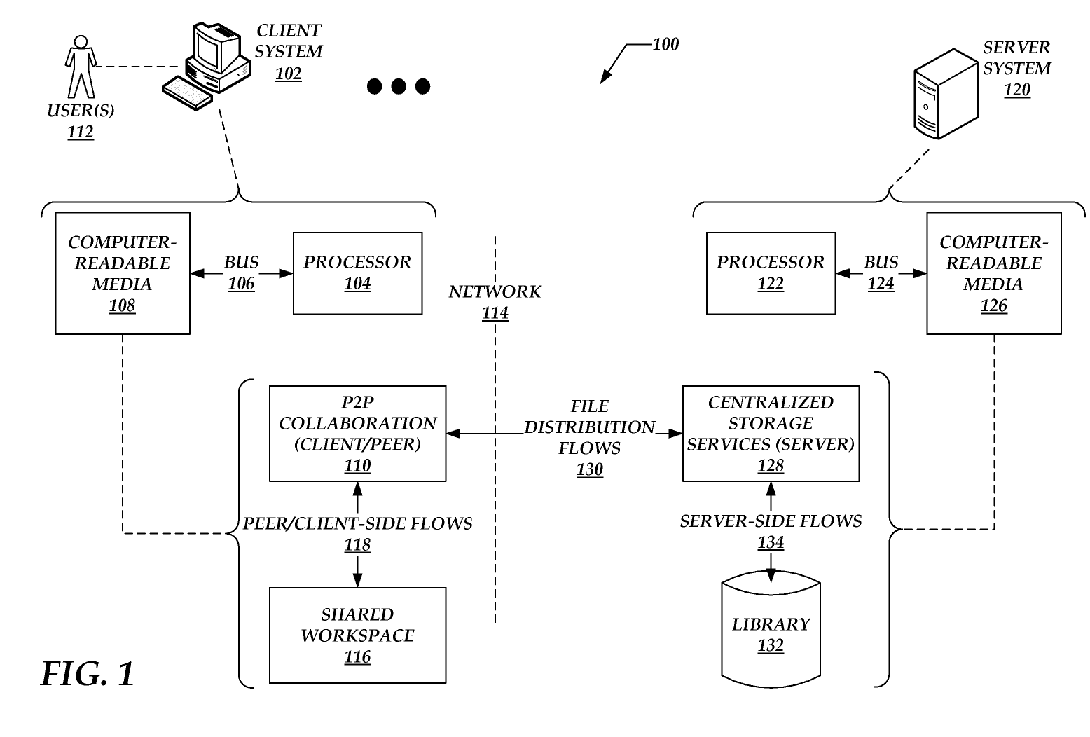

FIG. 1 illustrates systems or operating environments, denoted generally at 100, for enhanced client and server systems for operating collaboratively within shared workspaces. These systems 100 may include one or more client systems 102, with FIG. 1 illustrating one client system for clarity only. However, implementations of the description herein may include any number of client systems. It is noted that some, but not necessarily all, of the client systems may have access to server systems (described in more detail below).

Turning to the client systems 102 in more detail, these may include one or more processors 104, which may have a particular type or architecture, chosen as appropriate for particular implementations. The processors 104 may couple to one or more bus systems 106 chosen for compatibility with the processors 104.

The client systems 102 may also include one or more instances of computer-readable storage media 108, which couple to the bus systems 106. The bus systems may enable the processors 104 to read code and/or data to and/or from the computer-readable storage media 108. The media 108 may represent storage elements implemented using any suitable technology, including but not limited to semiconductors, magnetic materials, optics, or the like. The media 108 may include memory components, whether classified as RAM, ROM, flash, or other types, and may also represent hard disk drives.

The storage media 108 may include one or more data structures and modules of instructions that, when loaded into the processor 104 and executed, cause the client systems 102 to perform various tools and techniques relating to browser-independent animation engines. Examples of these modules may include a peer-to-peer (P2P) collaboration application 110 (herein, the “P2P application”). In general, the P2P application 110 may enable one or more users 112 to collaborate with other users accessing other client systems 102 (not shown in FIG. 1), by communicating over one or more networks 114. These networks 114 generally represent any protocols, adapters, components, and other general infrastructure associated with wired and/or wireless communications networks. Such networks 114 may be global, regional, local, and/or personal in scope and nature, as appropriate in different implementations.

The P2P applications 110 operating on one or more of the client systems 102 may establish and maintain a shared workspace 116. As detailed further throughout this description, the shared workspace 114 may enable different users 112 to collaboratively access and edit a variety of different shared folders, documents, objects, and the like. FIG. 1 generally represents at 118 data and command flows between the P2P application 110 and the shared workspace 116.

The operating environments 100 may also include one or more instances of server systems 120. These server systems 120 may include one or more processors 122, which may have a particular type or architecture, chosen as appropriate for particular implementations. The processors 122 may or may not have the same type and/or architecture as the processors 104. The processors 122 may couple to one or more bus systems 124 chosen for compatibility with the processors 122.

The server systems 120 may also include one or more instances of computer-readable storage media 126, which couple to the bus systems 124. The bus systems may enable the processors 122 to read code and/or data to and/or from the computer-readable storage media 126. The media 126 may represent storage elements implemented using any suitable technology, including but not limited to semiconductors, magnetic materials, optics, or the like. The media 126 may include memory components, whether classified as RAM, ROM, flash, or other types, and may also represent hard disk drives.

The storage media 126 may include one or more data structures and modules of instructions that, when loaded into the processor 122 and executed, cause the server systems 120 to perform various tools and techniques relating to enhanced client and server systems for operating collaboratively within shared workspaces. For example, these modules may provide one or more instances of server-side applications that provide centralized storage and file distribution, denoted generally at 128, with which the client systems 102 may interact. FIG. 1 generally denotes at 130 these interactions between the server systems 120 and the client systems 102. In general, examples of these interactions 130 may include requests from the client systems 102 for particular files or other content stored on the server systems 120. Once received from the server systems, such files or other content may be shared between two or more of the client systems, which may have peer relationships with one another.

Generally, the server system may perform specialized functions not otherwise performed by the client systems 102. For example, the server system 120 may provide centralized file storage and distribution, backup, administrative, managerial, or other services on behalf of the client systems 102, in connection with providing files or content to the client systems 102. In turn, the client systems 102 may establish peer relationships with one another, by which they may collaborate on the files or content received from the server system.

The storage media 126 may also include libraries or storage elements 132, which may contain any number of folders, files, or other objects that may be shared between client systems and server systems for collaboration. Although FIG. 1 illustrates one example of the library 132, it is noted that implementations of the server system 120 may include any number of libraries 132 or other storage elements, as appropriate. FIG. 1 denotes at 134 server-side flows between the server-side application 128 and the library 132.

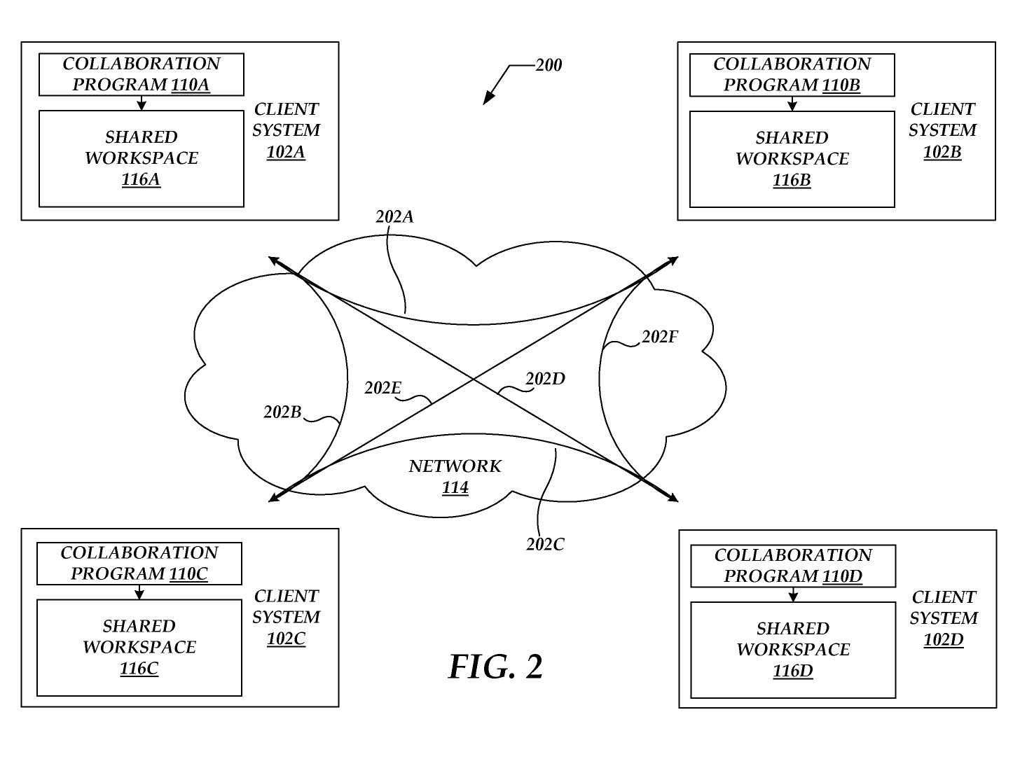

FIG. 2 is a block diagram illustrating additional aspects of the operating environments shown in FIG. 1. Turning now to FIG. 2, additional details will be provided regarding illustrative operating environments and several software components provided by the embodiments presented herein. In particular, FIG. 2 shows aspects of a system 200 for facilitating collaboration and communication among members of small groups. The system 200 illustrated in FIG. 2 includes several client systems, carried forward at 102a-102d, which are connected to one another via a network, carried forward at 114. In particular, the client systems 102a-102d may communicate with one another directly through network connections 202a-202f. It should be appreciated that although the client systems 102a-102d are described herein as being standard desktop computer systems, other types of computer devices may be utilized. For instance, communication appliances and other types of communication devices, including handheld and wireless devices may be utilized. Similarly, although the network 114 is described herein as being the Internet, virtually any other type of local area network, wide area network, or wireless network may be utilized to facilitate the communication described herein.

As also illustrated in FIG. 2, the client systems 102a-102d are configured to execute respective instances of a client-side P2P collaboration program, carried forward at 110a-110d (collectively, collaboration program 110). The collaboration programs 110 may be executable computer programs designed to facilitate collaboration and communication among members of small groups. Through the use of the collaboration program 110, respective instances of a shared workspace (carried forward as 116a-116d, and referred to collectively as shared workspaces 116) can be created. As will be described in greater detail below, the shared workspaces 116 may be utilized to store documents, content, and other information and to share this information among users of the computers 102a-102d. For instance, a user of the client system 102a may create the shared workspace 116a through the collaboration program 110a. The user of client systems 102a may then invite users of the client systems 102b-102d to join and become an active member of the shared workspace 116a. Assuming that these invited users respond to these invitations, the collaboration program 110a may send them respective copies of the workspace 116a, with these copies then being installed respective onto the client systems 102b-102d as shared workspaces 116b-116d.

According to embodiments, data that is transmitted between the computers 102a-102d to synchronize the contents of the shared workspaces 116 may be encrypted. The shared workspaces 106 may also be encrypted on any mass storage devices provided by the client systems 102a-102d. It should be appreciated that by storing a local copy of the shared workspace on each of the computers 102a-102d, users of the computers 102a-102d may remain connected to the shared data. For instance, in one embodiment, one of the client systems 102a-102d may comprise a portable computer system. In this embodiment, if the portable computer system is taken offline from the network 114, the shared workspace 116 will remain on the portable computer system for access by the user. Any modifications to the shared workspace 116 while the portable computer system is offline will be synchronized to the other computers when the portable computer returns online. In this manner, the collaboration program 110 may enable the shared workspaces 106 stored in the client systems 102a-102d to be continually synchronized with one another, so that the members of the shared workspace 106 have access to the same data.

According to embodiments, the changed data in a shared workspace 116 is transmitted to the other computers by transmitting only the changes to the shared workspace 116. One methodology for transmitting only the changes to a shared workspace is described in U.S. Patent Publication No. US2007/0255787 entitled “Method and Apparatus for Maintaining Consistency of the Shared Space Across Multiple Endpoints in a Peer-to-Peer Collaborative Computer System”, which was filed on Jun. 22, 2007, is assigned to the assignee of the instant patent application, and is expressly incorporated herein by reference in its entirety.

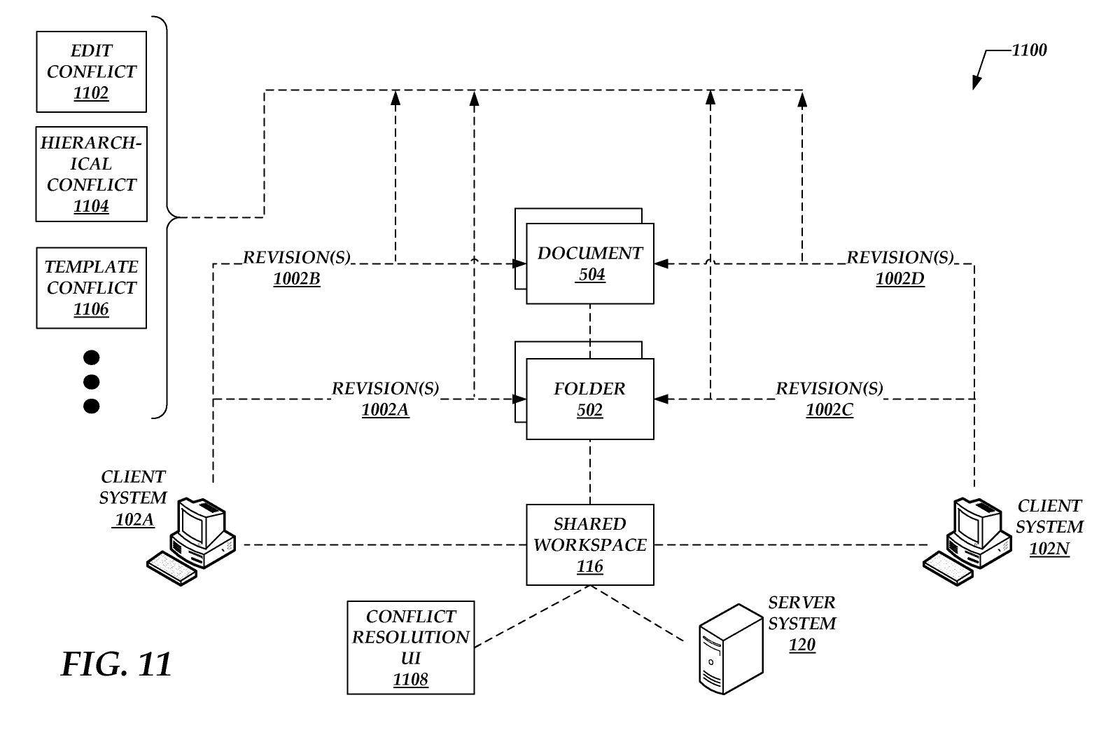

As discussed briefly above, when any one member of a shared workspace 116 makes a change to the shared workspace 116, that change is sent to the other members. If a member is offline and not connected to the network 114 at the time the change is made, the change is queued and synchronized to other workspace members. When the offline member comes back online, that member's copy of the shared workspace 116 is updated. It should be appreciated that although FIG. 11 provides examples of a peer-to-peer topology, other embodiments may be utilized that include a server computer that assists in the synchronization of the shared workspace 116 between the computers 102a-102d. It should also be appreciated that while in one implementation the collaboration program 110 comprises the GROOVEL™ collaboration program from MICROSOFT CORPORATION of Redmond, Wash., other collaboration programs from other vendors may be utilized to implement the concepts and technologies presented herein.

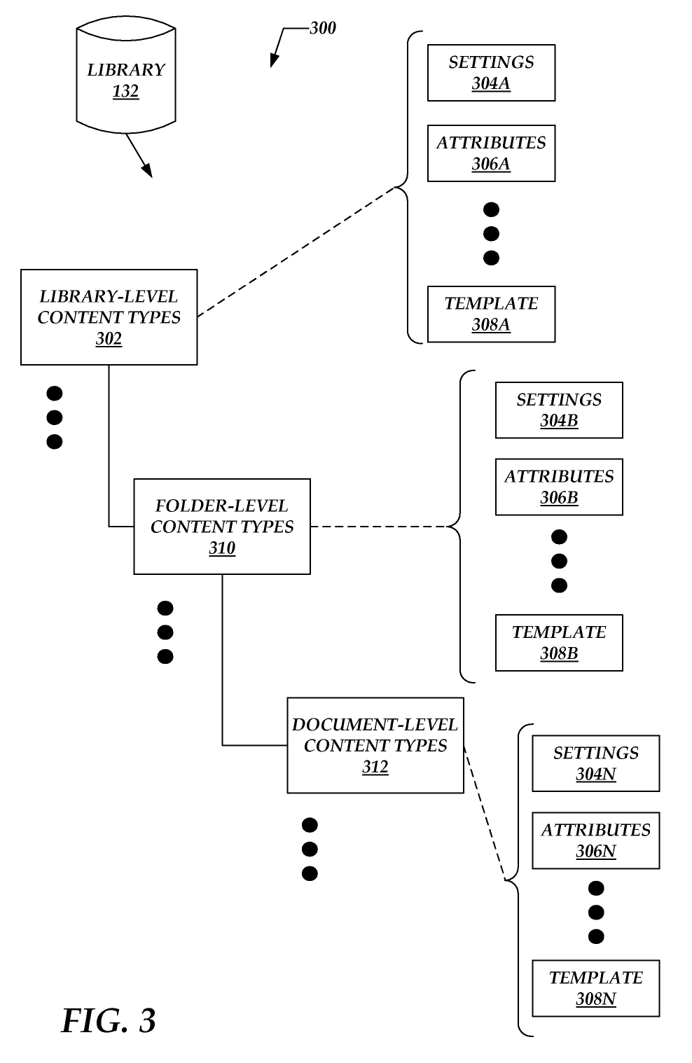

Having described the components of the overall operating environments 100 and 200 as shown in FIGS. 1 and 2, the discussion now turns to a more detailed description of the libraries 132. This description is now provided with FIG. 3.

FIG. 3 illustrates data structures and hierarchies, denoted generally at 300, relating to the libraries shown in FIG. 1. For convenience of description, but not to limit possible implementations, FIG. 3 may carry forward some elements from previous drawings, and denote them with identical reference numbers. For example, FIG. 3 carries forward an example library at 132.

Turning to the libraries 132 in more detail, the libraries 132 may include representations of folders, documents, and other objects, referred to collectively as items. The libraries 132 may also include representations of content types, which for the purposes of this description may refer to reusable collections of settings and attributes that define categories of data. Content types may contain a global set of properties that may assume various values. Files or folders contained within the libraries may have a single content type, as well as specifying values for the properties contained within those content types. Within a given folder, the folder may define a content type that is allowed to any files or sub-folders contained within the given folder, in some cases restricting the set of content types available globally across the library. A client application may present the content type property information available for a given folder or file, when presenting list views on a client system.

Content types may be defined at the library level, as represented at 302. These library-level content types may include settings 304a, attributes 306a, templates 308a, as well as other examples not shown in FIG. 3. Content types defined at the library level may be scoped to be used at the level of folders included within the libraries 132. FIG. 3 denotes at 310 examples of content types scoped at the folder level. These folder-level content types may include settings 304b, attributes 306, templates 308b, as well as other examples not shown in FIG. 3.

Content types may also be assigned at the level of documents included within folders. FIG. 3 denotes at 312 examples of content types assigned at the document level. These document-level content types may include settings 304n, attributes 306n, templates 308n, as well as other examples not shown in FIG. 3.

The items included within the library 132 may be assigned a respective content type. For example, documents within the library may derive from the document-level content type 312, folders within the library may derive from the folder-level content type 310, and so on.

Within a given library 132, a server-side application (e.g., 128 in FIG. 1) may specify eligible content types at the library-level 302, at the folder-level 310, and at the document-level 312. In turn, when particular client systems (e.g., 102 in FIG. 1) access the libraries 132, a client-side P2P application (e.g., 110 in FIG. 1) may expose the content types available at these different levels accordingly. For example, the client-side P2P application may provide one or more tools that enable users to create new files, new folders, or other new items. In connection with creating these new items, the client-side P2P application may provide a list of eligible or available content types available for creating these new items.

In example scenarios, content types derived from the document-level content type 312 may define a document template 308n to be used in creating new instances of that content type. In general, the client-side and server-side applications may synchronize the content types at the various levels shown in FIG. 3. The client-side P2P applications may also enable users to create new instances of documents or other objects using the templates included as part of the content types.

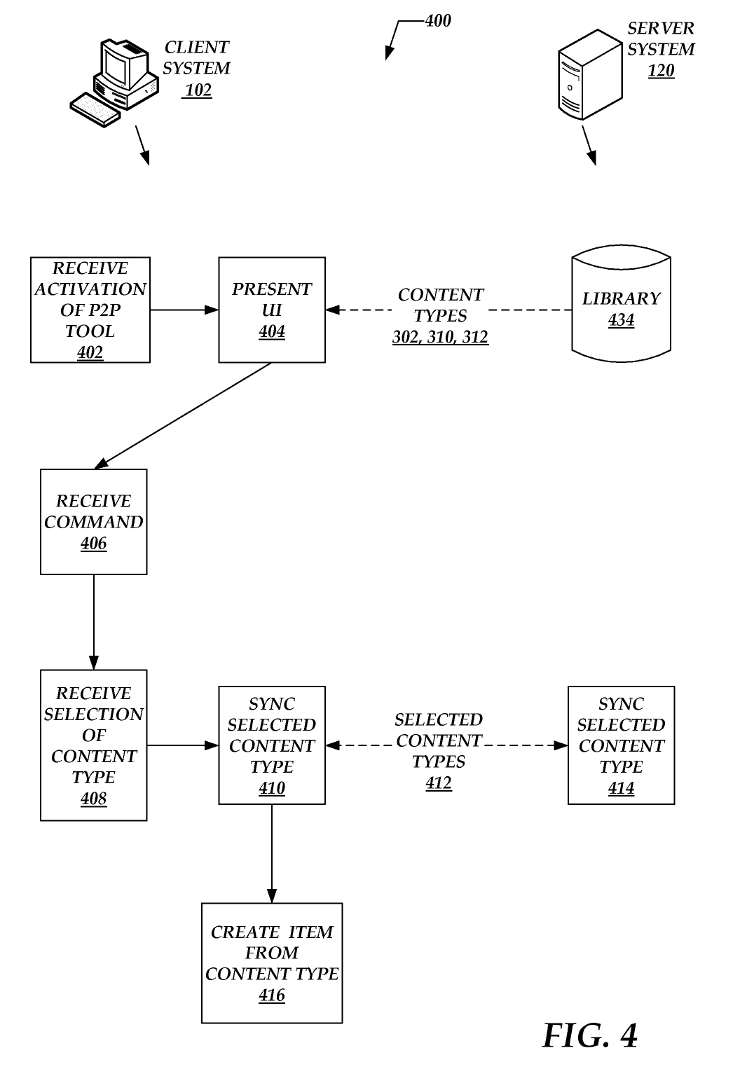

Having described the data structures or data hierarchies for the libraries 132 in FIG. 3, the discussion now turns to descriptions of example process flows that may operate with these libraries. This description is now provided with FIG. 4.

FIG. 4 illustrates process flows, denoted generally at 400, that may operate with the libraries 132 shown in FIG. 3. For purposes of this description, but not to limit possible implementations, the process flows 400 are illustrated and described in connection with the client system 102, the server system 120, and the library 132. However, implementations of this description may perform at least portions of the process flows 400 using other components without departing from the scope and spirit of this description. In addition, these process flows are described as proceeding in certain orders only for purposes of this description, and implementations of these process flows may proceed in different orders as well.

In addition, for convenience of description, but not to limit possible implementations, FIG. 4 may carry forward some elements from previous drawings, and denote them with identical reference numbers. For example, FIG. 4 carries forward an example of the client system 102, the server system 120, and the library 132.

Turning to the process flows 400 in more detail, block 402 represents receiving an indication that a user has activated a tool for creating a new file, a new folder, or other type of new item. For example, the P2P application 110 may provide an icon representing the tool in a command ribbon or a context menu. In turn, the user 112 may initiate the tool to create the new item, for example by clicking or otherwise activating this icon.

Block 404 represents presenting a user interface in response to the activation represented in block 402. For example, block 404 may include presenting a list of content types that are available for creating a new folder, file, or other item. FIG. 4 carries forward examples of these content types at 302, 310, and 312, as represented within the library 132.

Block 406 represents receiving a command from the user, entered through the UI presented in block 404. For example, block 406 may include receiving a command to create the new file, folder, or other item.

Block 408 represents receiving a selection of a content type to be used in creating the new item. In turn, block 410 may include syncing the content type selected for the newly-created item, between the client system 102 and the server system 120. FIG. 4 represents this sync generally at 412, which may occur between blocks 410 on the client system 102 and a complementary sync operation occurring on the server system 120, represented generally at 414.

Block 416 represents creating the selected item in response to the user command received in block 406. In addition, block 416 may include deriving the newly-created item from the content type selected in block 408. For example, block 416 may include creating one or more new documents within a given folder, using content type information in the form of a document template (e.g., 308n shown in FIG. 3).

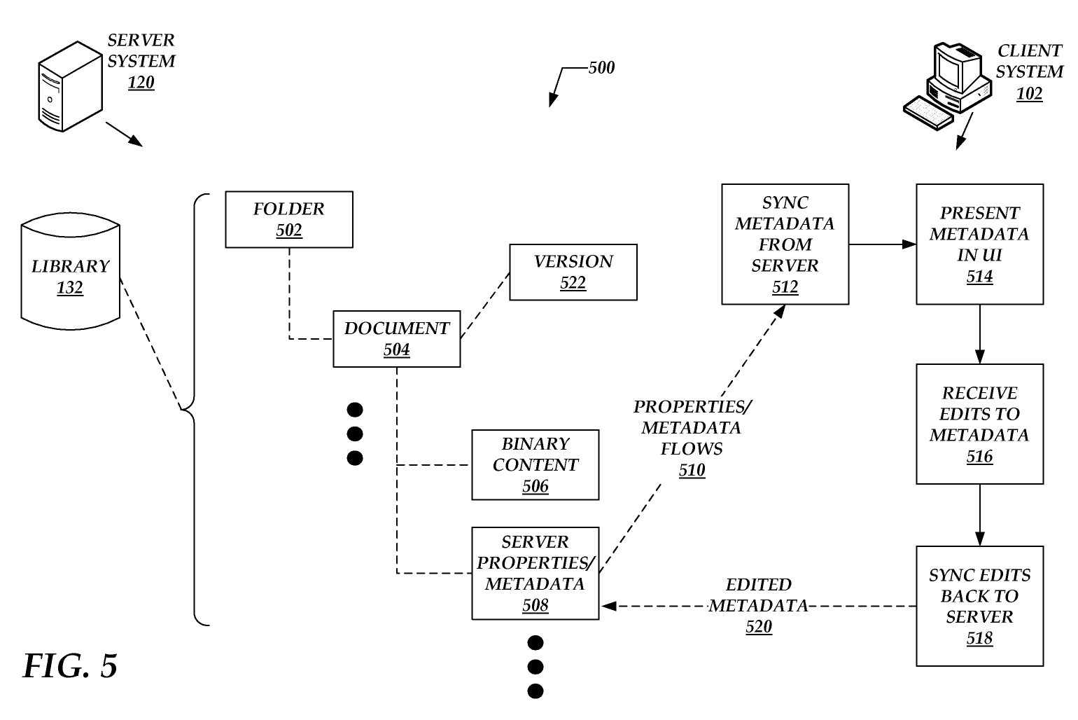

Having described the process flows 400 in FIG. 4, the discussion now turns to a description of components and data flows relating to viewing and editing metadata and other server properties between the server systems and client systems. This description is now provided with FIG. 5.

FIG. 5 illustrates components and data flows, denoted generally at 500 by which server systems may enable client systems to view and edit metadata and other server properties. For convenience of description, but not to limit possible implementations, FIG. 5 may carry forward some elements from previous drawings, and denote them with identical reference numbers. For example, FIG. 5 carries forward an example client system at 102, an example server system at 120, and an example library at 132.

Turning to FIG. 5 in more detail, the server system 120 may maintain one or more instances of the libraries 132. In turn, the libraries may contain any number of folders 502, documents 504 within those folders, as well as other objects or items not explicitly shown in FIG. 5.

Turning to the documents 504 in more detail, the documents may be associated with binary content 506. The binary content 506 represents the data that is accessed and loaded when a given user opens a given document 504 using appropriate applications (e.g., Word processing, spreadsheets, database management, e-mail or contact management, or the like).

In addition to the binary contents 506, the documents 504 may be associated with server properties or metadata, denoted generally at 508. In general, the server properties or metadata 508 provide additional information or description relating to the binary content 506. As a non-limiting example, the binary content 506 may represent a specification document generated in connection with an ongoing software development project. The metadata 508 associated with this specification document may indicate who authored the document, may identify the project manager in charge of the development project, may specify workflow associated with the project, may specify distribution lists associated with reviewing and approving specification, and the like.

The server system 120 and a client system 102 may sync representations of the documents 504 with one another. In the example shown in FIG. 5, the server system 120 may sync representations of the server properties or metadata 510 to one or more of the client systems 102. FIG. 5 represents these metadata flows generally at 510.

At the example client system 102, block 512 represents syncing at least one instance of information related to the document 504 from the server system 120. In the example shown, block 512 may include syncing the metadata associated with the document from the server system. In addition, block 512 may also include syncing the binary content 506 associated with the document, although in the interest of clarity, FIG. 5 does not illustrate syncing the binary content.

Block 514 represents presenting the synced metadata in a suitable user interface (UI) displayed on the client system 102. In example scenarios, the client system 102 may sync any number of documents 504, as well as related binary content 506 and metadata 508, from the server system. In turn, block 514 on the client system may include populating a suitable UI for presentation to a user. This UI may include representations of documents and related metadata as synced from the server system, and as available for viewing and/or editing on the client system.

Block 516 represents receiving edits to the metadata that was synced from the server system. More specifically, block 516 may include receiving edits to the metadata, as provided by a user (e.g., 112) accessing the client system 102 and interacting with the UI presented in block 514. Once a given instance of metadata has been edited by a user, block 516 may include marking or otherwise designating the edited metadata for syncing back to the server system 120.

Block 518 represents syncing any metadata, which was edited on the client system 102, back to the server system 120. For example, block 518 may include identifying any instances of metadata that were marked or otherwise designated in block 516 as having been edited on the client system 102. FIG. 5 denotes the edited metadata at 520 as synced back to the server system 120.

As detailed further elsewhere herein, the tools and techniques provided in this description may enable any number of client systems to create new folders and/or documents, as well as modifying or deleting existing folders, and documents. In scenarios in which client systems modify existing documents, the client systems 102 and/or the server systems 120 may establish a versioning scheme, in which the library 132 associates a version number or other suitable identifier with versions of the documents 504.

In some cases, the server system may establish a numbering scheme, in which version numbers are expressed in the following format: [major][minor][revision][build]. In such example scenarios, the server system may control the major and minor portions of the version number, and the client systems may control the revision and build portions of the version number.

In example scenarios, when a given user wishes to check in a revised document into the server system 120, the user may be prompted to indicate whether this revision is a major or minor revision. Depending on how the user responds, the server system may automatically update the version number associated with the revision being checked-in. In general, FIG. 5 provides an example of revisions or version numbers at 522, as associated with particular documents 504.

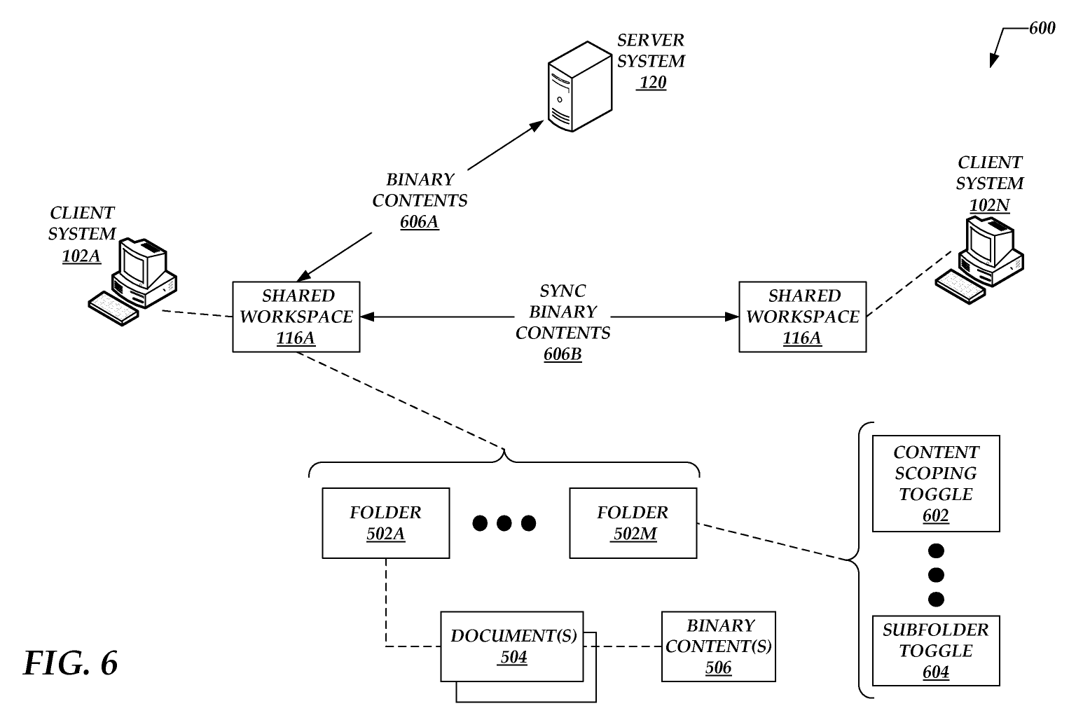

Having described the components and flows shown in FIG. 5, the discussion now turns to a description of components and flows related to enabling client systems to sync and edit binary contents of the shared documents. This description is now provided with FIG. 6.

FIG. 6 illustrates components and data flows, denoted generally at 600, that enable peer or client systems to sync binary contents of the files or documents from server systems. For convenience of description, but not to limit possible implementations, FIG. 6 may carry forward some elements from previous drawings, and denote them with identical reference numbers. For example, FIG. 6 carries forward example client systems 102a and 102n (collectively, client systems 102), an example server system 120.

As shown in FIG. 6, the server system 120 may distribute contents to/from shared workspaces (carried forward at 116a and 116n from FIG. 1), through which two or more client systems 102a and 102n may respectively cooperate or collaborate. More specifically, the server system 120 may make available to the client systems 102 any number of folders and/or files, through the shared workspaces 116. As described elsewhere herein, the server system may maintain one or more storage elements, libraries, or other data structures in a house or store these folders, files, or other objects. In the interests of conciseness and clarity, FIG. 6 does not illustrate these storage elements, but FIG. 1 provides an example library at 132.

FIG. 6 carries forward examples of folders, denoted at 502a and 502m (collectively, folders 502). The local workspaces 116a and 116n may maintain respective instances of the folders 502 and related contents. However, FIG. 6 illustrates the folders 502 as contained within the workspace 116a only for clarity of description. Turning to the folder 502a as an example, this folder may include any number of files, carried forward at 504. As described above with FIG. 5, the documents 504 may be associated with binary contents 506, which may be synced between a server system 120 and any number of client or peer systems 102. The folders 502 and related documents 504 may be arranged conceptually in a tree structure, with the folders being nodes within the tree, and the documents being leaves.

A given user at a given client system may specify on a per-folder basis how to synchronize the binary contents 506 on that given client system. Turning to the folder 502m as an example, the folders 502 may be associated with respective instances of a content scoping toggle 602. By setting the content scoping toggle appropriately, users who automatically sync the contents of their client systems may specify which particular contents to sync. More specifically, a user may enable or disable the content scoping toggle 602 for a given folder via a context menu of a folder, or from a command ribbon, presented based on a current selection within a view of the folder and document tree. If the content scoping toggle 602 is enabled for a given folder, the binary contents of files within that folder are synchronized across other client systems 102 and the server system 120. Otherwise, the binary contents of files within that folder are not synchronized.

In some cases, the folders 502 may include one or more subfolders within the tree structure. In such cases, a subfolder toggle 604 may indicate whether to include any of these subfolders in the synchronization election represented by the state of the auto-sync toggle 602. It is noted that the toggles 602 and 604 may be implemented as checkboxes within a suitable UI, prompts or dialog box is directed to users, or any other suitable device or mechanism.

In general, the synchronization decisions represented by the states of the toggles 602 and 604 may affect the client systems and related users operating within a given shared workspace 116. Typically, at least one of these client systems 102 may request and receive the file content from the server system 120. In turn, these requesting client systems may share the file content with other client systems operating as peers. More specifically, the client systems 102a and 102n may operate as peer endpoints within the given shared workspace 116 to receive the synchronized binary contents as specified or requested. FIG. 6 denotes at 606a examples of synced binary contents flowing between the server system 120 and the client system 102a. In turn, the client system 102a may, as denoted at 606b, sync these binary contents to and/or from the client system 102n, in the course of collaboration efforts between the client systems 102. Finally, the client system 102a may sync the results of these collaboration efforts back to the server 120 at any convenient time, as also denoted at 606a.

In this manner, the components and data flows 600 shown in FIG. 6 enable the client systems 102 and server systems 120 to define which content is synchronized through the shared workspace 116. Put differently, the components and flows 600 enable the client and server systems to establish and enforce content scoping within the shared workspace.

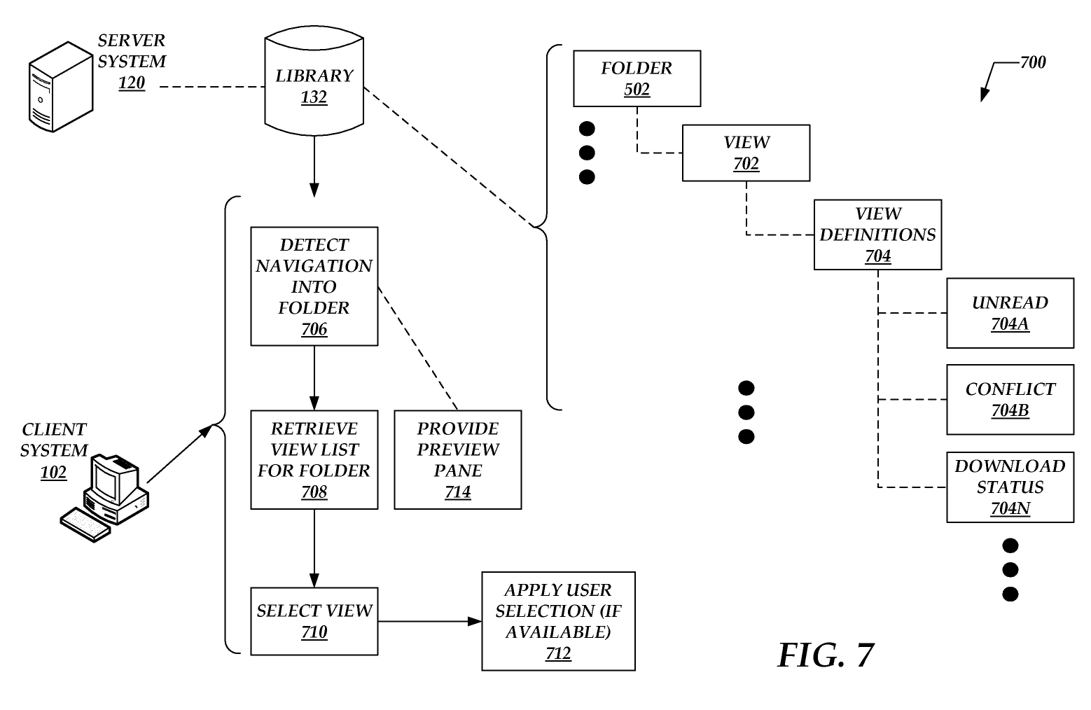

Having described the components and data flows 600 in FIG. 6, the discussion now turns to a description of components and flows related to managing public and private views of folders and documents on client and server systems. This description is now provided with FIG. 7.

FIG. 7 illustrates components and flows, denoted generally at 700, related to managing public and private views of folders and documents on client and server systems. For convenience of description, but not to limit possible implementations, FIG. 7 may carry forward some elements from previous drawings, and denote them with identical reference numbers. For example, FIG. 7 carries forward an example server system at 120, an example client system at 102, and an example library at 132.

Turning to FIG. 7 in more detail, the server system 120 may maintain view definitions associated with particular folders within the library 132. FIG. 7 carries forward an example folder at 502, and includes a representation 702 of a view of documents contained within the folder 502. More specifically, the representation 702 may define one or more instances of view definitions, denoted collectively at 704.

Views implemented according to this description may be private views or public views. The server system provides private views only to particular users, while public views are made available to all users accessing the server. For a given user accessing a given client system, the server system 120 may identify any private views defined for that given user, and present these private views on the given client system. In general, the description below relating to views may apply equally to public or private views, unless expressly noted to the contrary.

These view definitions 704 may be presented within a user interface that includes columns corresponding to various instances of individual view definitions. Examples of the view definitions 704 may include client-supplied information used to populate various columns, such as a column 704a indicating whether particular documents or other items within the folder have been read or unread by particular users and/or client systems. A column 704b may indicate whether a conflict exists between revisions or other actions taken by two or more client systems on documents or other items within the folder 502. A column 704n may indicate, for given documents or other items within the folder 502, which (if any) client systems have downloaded those documents or other items.

The view definitions may also include server-supplied information used to populate various other columns, such as columns for file names, files sizes, author, etc. The client-supplied information above may be pre-pended to the view information that syncs in to the clients from the server.

As shown in FIG. 7, the server system 120 and the client system may sync the public views 702, along with syncing the folders 502 and other items within the library 132. Once the public views 702 are synced to a given client system 102, the client system may present a user interface that displays representations of the folder 502, along with any files or other items contained within the folder. In addition, the user interface presented on the client system may also display in columns representations of the various view definitions 704 (e.g., 704a, 704b, 704n, and/or other examples of view definitions).

At the given client system 102, a user may navigate to a given folder presented within a user interface by, for example, clicking or otherwise interacting with a representation of that folder. Block 706 represents detecting when the user has navigated into a given folder. In turn, block 708 represents retrieving a view list for the folder into which the user navigated in block 706.

Block 710 represents selecting the view to be used and presenting representations of the folder and related files or documents on the client system. More specifically, the view list retrieved in block 708 may specify which particular columns for view definitions (e.g., 704a-704n) are to be displayed on a given client system. In some cases, a given user may have previously selected a specified view selection. If such a specified user selection is available, block 712 represents applying that view selection to the representation of the folder and any contained files or other items.

Block 714 represents providing a preview pane that enables users accessing the client system 102 to view file contents, without opening the document for editing. In different implementations scenarios, the preview pane may be presented in any convenient location relative to a list view, which includes representations of files and/or folders available from the library 132. Depending on what a given user has selected within the list view, the preview pane may provide different levels of information. For example, if the user selects a given file for which a preview is available, the preview pane may provide the available preview. If the user selects a folder or an unsupported file type, the preview pane may indicate that no preview is available for a folder or the unsupported file type. If the user has not explicitly selected a file, the preview pane may prompt the user to select a file to preview. If the user selects multiple files, the preview pane may provide a preview of the last file selected. If the user selects a file that has not yet been downloaded to his or her client system, the preview pane may indicate that the file is not available for previewing until it has been downloaded. If the user selects a file that was deleted, the preview pane may prompt the user to select another file to preview.

In some cases, while a given user is previewing files on a given client system 102, another user on another client system may generate revisions or updates to the files being previewed. In such cases, the preview pane may automatically incorporate these revisions or updates.

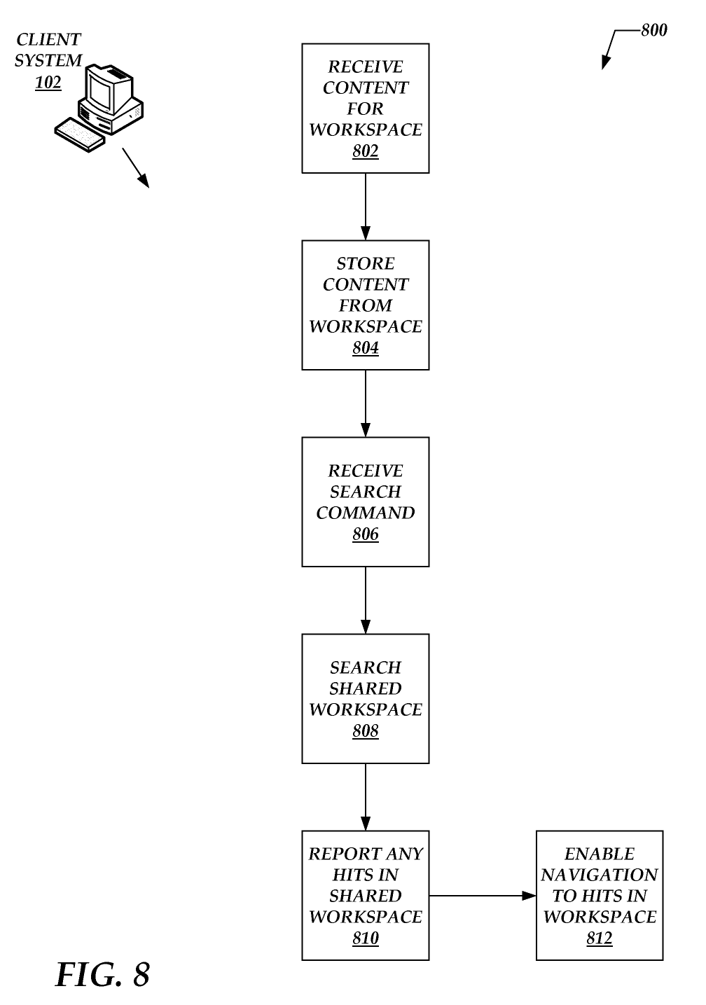

Having described the components and flows 700 shown in FIG. 7, the discussion now turns to a description of process flows for integrating content accessible through the shared workspace with a search function operating on client systems. This discussion is now presented with FIG. 8.

FIG. 8 illustrates process flows, denoted generally at 800, for integrating content accessible through a shared workspace with a search function operating on client systems. For convenience of description, but not to limit possible implementations, FIG. 8 may carry forward some elements from previous drawings, and denote them with identical reference numbers. For example, FIG. 8 carries forward an example client system at 102. In addition, while the process flows 800 are described in connection with the client system 102, implementations of this description may perform some or all of the process flows 800 other components, without departing from the scope and spirit of this description.

Turning to the process flows 800 in more detail, block 802 represents receiving content for access or collaboration through a shared workspace. FIG. 1 provides an example of a shared workspace at 116. Through this shared workspace, any number of client and/or server systems may access and collaborate on folders, as well as documents, files, or other items contained within those folders. As various revisions occur locally on the client and/or server systems, these systems may sync revisions to one another through the shared workspace. Accordingly, the content received in block 802 may represent folders, as well as files, documents, or other objects contained within those folders.

Block 804 represents storing or persisting content received through the shared workspace locally on the given client system 102. More specifically, block 804 may include making this content within the shared workspace available to local search functions executing on the client system 102.

Block 806 represents receiving a search command submitted by a local user accessing the client system 102. The search command may reference or incorporate a given search string of interest to the user.

Block 808 represents searching the shared workspace in response to the command received locally at the client system 102. More specifically, block 808 may include searching the shared workspace for any occurrences of the given search string received in block 806. Block 808 may include searching the shared workspace, in addition to any other storage elements that are maintained locally at the client system 102, but are not otherwise available to other systems remote from the client system 102.

Block 810 represents reporting any hits for the input search string detected or located within the shared workspace during the search performed in block 808. For example, if at least one instance of an input search string occurs within content synced to the client system 102, block 810 may include determining where these hits occur within the shared workspace. Block 810 may also include determining where hits occur within the shared workspace, in addition to any local storage maintained by the client system 102.

Block 812 represents enabling navigation to any hits occurring within the shared workspace (e.g., 116). For example, block 812 may include creating links within a user interface, with these links being responsive to user input or activation to navigate to where the hits occur within the shared workspace.

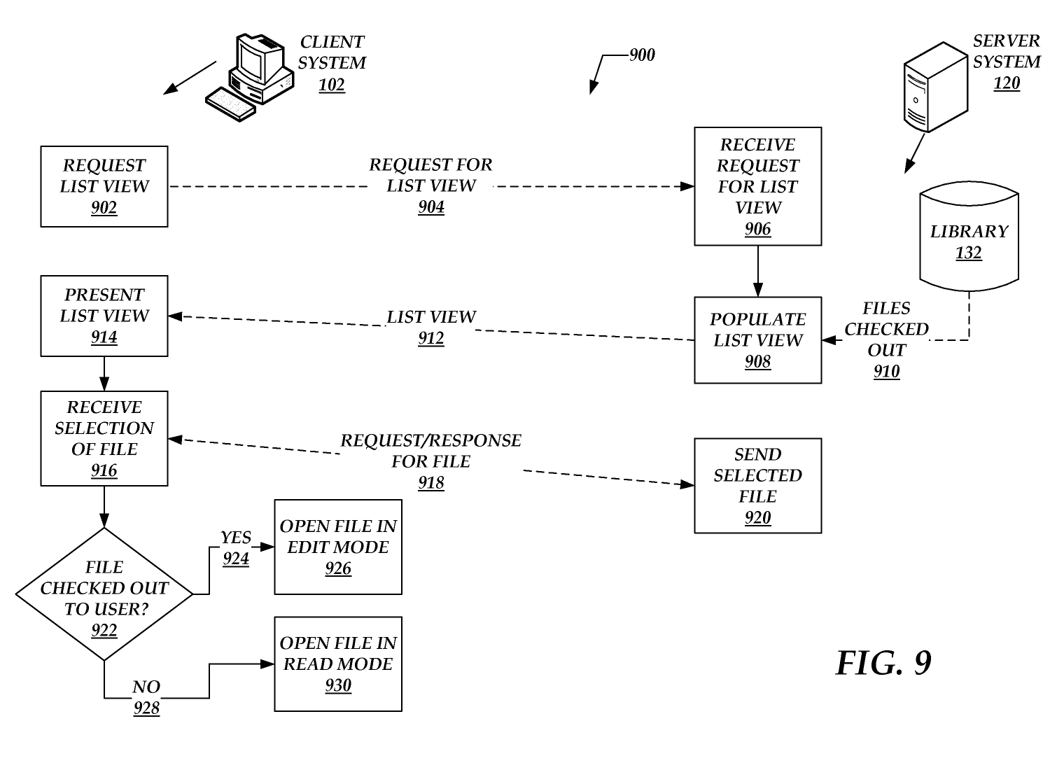

Having described the process flows 800 in FIG. 8 for integrating desktop search functions with content residing in a shared workspace, the discussion now turns to a description of components and flows by which client systems may check out items from server systems. This description is now provided with FIG. 9.

FIG. 9 illustrates components and flows, denoted generally at 800, by which client systems may check out items from server systems. For convenience of description, but not to limit possible implementations, FIG. 9 may carry forward some elements from previous drawings, and denote them with identical reference numbers. For example, FIG. 9 carries forward an example client system at 102, an example server system at 120, and an example library at 132.

Turning to FIG. 9 in more detail, at the client system 102, block 902 represents requesting a list view from the server system 120. This list view may take the form of a user interface that contains representations of folders and/or files available for access within a shared workspace (e.g., 116) facilitated by the server system 120. FIG. 9 denotes at 902 an example request for the list view.

At the server system 120, block 906 represents receiving the request 904 for a list view from the client system 102. In turn, block 908 represents populating the list view. More specifically, block 908 may include retrieving information 810 from storage elements (e.g., the library 132), with this information indicating which files have been checked out by particular client systems. For example, server systems may provide a given user a write lock on a given file, with the user being granted the exclusive right to edit the file. Those edits are not visible to others until that user checks the file back in. When the user checks the file back in, the server may determine whether to version the file afterwards. In addition, block 908 may include sending or transmitting a representation of the requested list view to the client system 102, as denoted at 912.

At the client system 102, block 914 represents presenting a user interface that displays representations of the list view 912 received from the server system 120. As detailed elsewhere herein, the list view 912 may include representations of various folders, files, or other objects available for syncing from the server system 120, for collaborative operations within a shared workspace (e.g., 116).

Block 916 represents receiving a selection of an item included within the list view presented in block 914. For example, block 916 may include receiving a user selection of a representation of a folder, or a file or document contained within a folder. if the selected folder, file, or other object (collectively, “item”) is not already synced to the client system 102, and the selected item may be requested and received from the server system 120, as represented generally at 918. For example, referring briefly to the server system 120, block 920 represents sending or syncing the selected item to the client system 102.

In some cases, items presented in the client system 102 in block 914 may already have been checked out to that client system. Recall that the list view 912 as transmitted to the client system 102 may incorporate information 910 indicating which files or items have been checked out by particular client systems. In these scenarios, block 922 represents determining whether the selected file has been checked out to the user who selected the item in block 916. If so, the client system 102 may take Yes branch 924, proceeding to block 926, which represents opening the selected file in edit mode within a shared workspace (e.g., 116).

Returning to decision block 922, if the selected file has not been checked out to the user who selected the item in block 916, then the client system 102 may take No branch 928 to block 930. Block 930 represents opening the selected file in a read mode within the shared workspace.

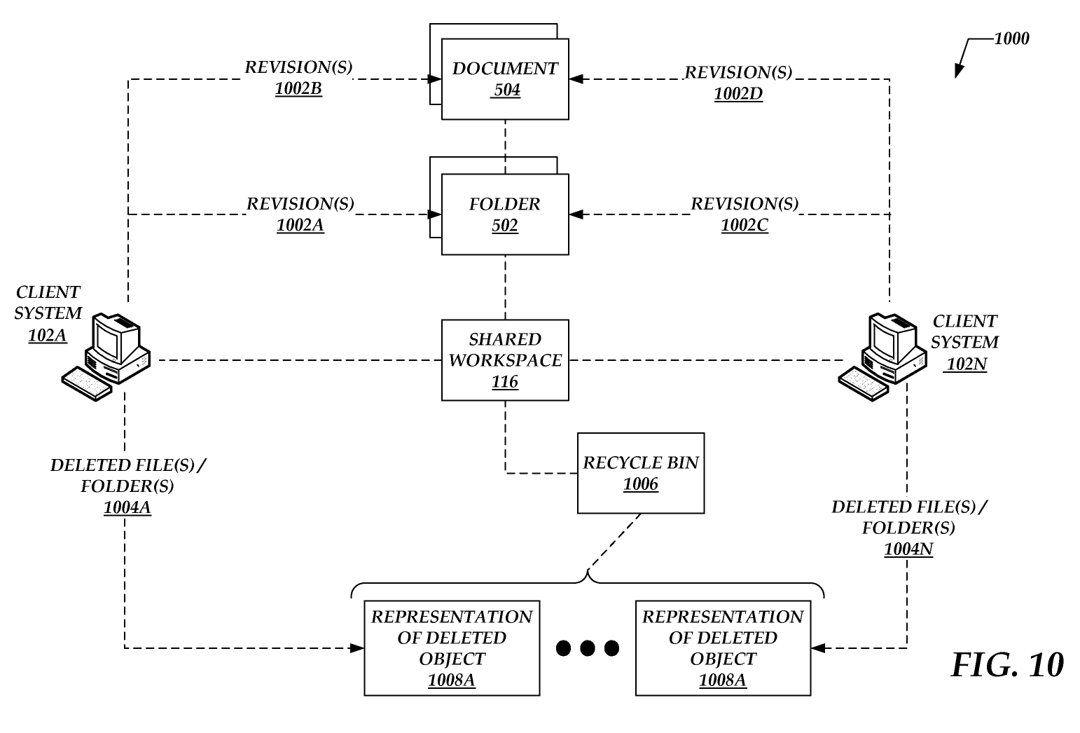

Having described the components and flows 900 by which client systems may check out items from server systems in FIG. 9, the discussion now turns to a description of components and data flows related to a recycle bin structure that may be included in connection with the shared workspace. This description is now provided with FIG. 10.

FIG. 10 illustrates components and data flows, denoted generally at 900, related to a recycle bin structure associated with a shared workspace by which two or more client systems may collaborate. For convenience of description, but not to limit possible implementations, FIG. 10 may carry forward some elements from previous drawings, and denote them with identical reference numbers. For example, FIG. 10 carries forward examples of client systems at 102a and 102n, an example shared workspace at 116, as well as example folders at 502, and example documents at 504.

Turning to FIG. 10 in more detail, the shared workspace 116 may enable two or more client systems 102a and 102n (collectively, client systems 102) to collaboratively access any number of folders 502, which may contain any number of documents 504. Through the shared workspace 116, users associated with the client systems 102 may perform any number of revisions on the folders 502 and/or any documents 504 contained therein. In the example shown in FIG. 10, any revisions made through the client system 102a to the example folder 502 are denoted at 1002a, while any revisions made through that same client system 102a to the example document 504 are denoted at 1002b. Similarly, any revisions made through the client system 102n to the example folder 502 are denoted at 1002c, while any revisions made through the same client system 102n to the example document 504 are denoted at 1002d.

It is noted that FIG. 10 provides the examples of the revisions 1002a-1002d (collectively, revisions 1002) only to facilitate this description, but not to limit possible implementations of this description. In addition, it is noted that these revisions 1002 may represent any number of actions taken on the folders 502 and/or the documents 504. Examples of revisions to the folders 502 may include adding new folders, as well as copying, renaming, or deleting existing folders. Examples of revisions to the documents for over four may include adding new documents, editing or revising existing documents, deleting existing documents, as well as copying or renaming existing documents.

In some scenarios, one or more of the client systems 102 may delete certain objects (e.g., folders, and/or documents) through the shared workspace 116. For example, acting through the client system 102a, a given user may delete files and/or folders 1004a. Similarly, acting through the client system 102n, a given user may delete files and/or folders 1004n (collectively, deleted files/folders 1004).

In such scenarios, a UI presented in connection with the shared workspace on the client systems 102 may include an icon or other depiction of a recycle bin structure, denoted generally at 1006. The recycle bin structure 1006 may be shared between the client systems 102 access the shared workspace 116.

As items or objects 1004 are deleted within the shared workspace 116, the recycle bin structure 1006 may be updated to include representations of the deleted items or objects 1004. FIG. 10 denotes examples of these representations at 1008a and 1008m (collectively, representations 1008).

Once items are placed in a recycle bin structure 1006, the client systems 102 may perform certain operations on them, subject to consideration such as content type, user permissions, and the like. For example, a restore operation may return a deleted item (e.g. a folder, file, and the contents thereof) in the recycle bin structure to its previous location within a directory tree structure. If users have edit/add permissions, the restore function may be enabled. Conversely, for those users who do not have edit/add permissions, the restore function may be disabled.

If a directory path formerly associated with a deleted file or folder no longer exists when performing the restore operation, the restore operation may attempt to rebuild the directory path. If the directory path cannot be rebuilt, the user may be prompted to choose a new path in which to restore one or more of the previously deleted items.

In some cases, conflicts may exist between items placed in the recycle bin. In such cases, the recycle bin structure may prompt or otherwise requested that the user resolve the conflict before restoring one or more of the items involved in the conflict.

The recycle bin structure may also provide a “cut” operation, which may enable files or folders to be moved within the directory tree structure. The cut operation may be enabled according to edit permissions granted to particular users. Finally, an empty recycle bin operation may permanently delete the contents of the recycle bin, thereby freeing storage space.

The recycle bin structure 1006 may also display various properties associated with items in the recycle bin. examples of these properties may include, but are not limited to, any of the following:
an icon indicating whether a particular item is read or unread;
an icon associated with a column, indicating a type of files appearing within the column;
names for folders, files, or other items in the recycle bin (in some implementations, file extensions may be omitted);
original locations or full pathnames associated with items in the recycle bin structure;
indications of who created or deleted items in the recycle bin;
dates on which items in the recycle bin were deleted; and/or
sizes and/or types of items in the recycle bin.

Having described the examples of revisions and recycle bin structures in FIG. 10, the discussion now turns to a description of various types of conflicts that may arise between these revisions. This description is now presented with FIG. 11.

FIG. 11 illustrates components and data flows, denoted generally at 1100, pertaining to various types of conflicts that may arise between revisions. For convenience of description, but not to limit possible implementations, FIG. 11 may carry forward some elements from previous drawings, and denote them with identical reference numbers. For example, FIG. 11 carries forward examples of client systems 102a and 102n (collectively, client systems 102), examples of revisions 1002a-1002d (collectively, revisions 1002). FIG. 10 also carries forward examples of the shared workspace 116, which may enable the client systems 102 to collaboratively access and revise any number of folders 502. In turn, the folders may contain any number of documents 504.

Over time, as the client systems 102 perform various revisions to the folders and/or documents, various types of conflicts may arise between different revisions 1002a-1002d. For example, as represented generally at 1102, two or more of the revisions 1002 may experience edit conflicts. Examples of edit conflicts may include scenarios in which one client system edits some portion of a given document 504, and in which another client system edits the same portion of the same given document, resulting in this portion of the document having two different, contradictory states. In another example, two or more client systems may rename the given document to have two different, conflicting names. Similar examples might involve folders 502, rather than documents 504.

Other examples of conflicts may involve hierarchical conflicts, denoted generally at 1104. Examples of hierarchical conflicts may include scenarios in which one client system revises (e.g., edits, renames, or the like) a given document 504 within a folder 502, but another client system deletes the folder 502. Other examples may include scenarios in which one client system attempts to add a new file into a directory or folder deleted by another client system.

Template conflicts, denoted generally at 1106, may arise when different client systems employ different, incompatible templates to create new documents. Referring briefly back to FIG. 3, examples of document or file templates are shown at 308a-308n, and these templates may be defined at the library, folder, or document level by the library 132.

In cases where various types of conflicts may arise between revisions performed by different client systems 102, a suitable conflict resolution user interface (UI) 1108 may be exposed to the client systems 102a and 102n. In the example shown in FIG. 11, the server system 120 may populate and expose this conflict resolution UI 1108. In example scenarios, the conflict resolution UI 1108 may include representations of different conflicts, as well as providing descriptive information relating to the particular conflicts. The conflict resolution UI may also indicate any folders, documents, or other objects involved in particular conflicts, as well as indicating which client systems 102 participated in the conflicting revisions.

The various client systems 102a and 102n may present the conflict resolution UI 1108 to respective users accessing the client systems. In turn, the conflict resolution UI may enable these users to review and resolve the various conflicts by interacting through the shared workspace 116.

Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

In addition, certain process and data flows are represented herein as unidirectional only for the purposes of facilitating this description. However, these unidirectional representations do not exclude or disclaim implementations that incorporate bidirectional flows.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. At least one computer-readable storage medium having computer-executable instructions stored thereon which, when executed by a client system operable with at least one server system, cause the client system to perform a method comprising:
accessing a library maintained by the server system, wherein the library includes at least one folder that further includes at least one document, wherein the document is associated with binary content and metadata;
syncing the binary content and the metadata for the document from the server system to the client system;
revising the binary content and the metadata on the client system;
syncing the revised binary content and metadata to the server system, or to a further client system in a peer-to-peer relationship with the client system;
receiving an indication of at least one conflict involving the revisions made on the client system to the binary content or metadata, wherein the conflict further involves revisions made to the document on at least the further client system; and
enabling resolution of the conflict on the client system.

2. The storage medium of claim 1, wherein the library defines a plurality of content types that are available within the library, wherein the content types define respective sets of properties.

3. The storage medium of claim 2, wherein the library includes at least one folder, and wherein the library specifies for that folder at least a subset of the content types.

4. The storage medium of claim 3, wherein the folder specifies a value for at least one of the properties.

5. The storage medium of claim 1, wherein at least one of the content types defines a document template.

6. The storage medium of claim 1, further comprising instructions creating a new document on the client system, based on a document template synced from the server system to the client system.

7. The storage medium of claim 1, further comprising instructions enabling the client system to specify that all updates to the binary content of the document are to be synced automatically to the client system.

8. The storage medium of claim 1, further comprising instructions enabling the client system to specify that all updates to the binary content of all documents within the folder are to be synced automatically to the client system.

9. The storage medium of claim 1, wherein the instructions for receiving an indication of at least one conflict include instructions for receiving an indication of at least one conflicting edit made to the document on the client system and at least the further client system.

10. The storage medium of claim 1, wherein the instructions for receiving an indication of at least one conflict include instructions for receiving an indication of at least one hierarchical conflict made to the document on the client system and at least the further client system.

11. The storage medium of claim 10, wherein the instructions for receiving an indication of at least one hierarchical conflict include instructions for receiving a conflict arising between revisions made to the document on the client system and further revisions made to the folder on the further client system.

12. At least one computer-readable storage medium having computer-executable instructions stored thereon which, when executed by a server system operable with at least one client system, cause the server system to perform a method comprising:
provide a library that includes at least one folder, wherein the folder further includes at least one document;
associating a public view with the folder, wherein the public view specifies how information associated with the folder is to be presented in a user interface displayed on the client system;
detecting that a user accessing the client system has navigated into the folder;
sending a representation of the public view to the client system; and
enabling the client system to present the public view associated with the folder to the user.

13. The storage medium of claim 12, further comprising instructions enabling the client system to apply a view that was previously selected by the user, when presenting the folder to the user.

14. The storage medium of claim 12, further comprising instructions for providing a preview pane on the client system, in response to detecting that the user has navigated into the folder.

15. The storage medium of claim 14, further comprising instructions for detecting that the user has selected the document, and wherein the instructions for providing a preview pane include instructions for providing a preview of content included within the selected document.

16. The storage medium of claim 12, further comprising instructions for maintaining versioning information associated with at least the document.

17. The storage medium of claim 16, wherein the instructions for maintaining versioning information include instructions enabling the server system to define a first part of the version information, and enabling the client system to define a second part of the version information.

18. At least one computer-readable storage medium having computer-executable instructions stored thereon which, when executed by a client system operable with at least one server system, cause the client system to perform a method comprising:
receiving document content associated with a workspace shared with at least a further client system, as facilitated by the server system;
receiving at least one search command that references a search string;
searching the document content within the workspace for the search string; and
reporting any occurrences of the search string within the workspace.

19. The storage medium of claim 18, further comprising instructions enabling the user to navigate to any occurrences of the search string within the workspace.

20. The storage medium of claim 18, further comprising instructions for presenting at least one link on the client system, wherein the link is responsive to user input to navigate to at least one occurrence of the search string within the workspace.
